(19) United States
(12) Patent Application Publication
(10) Pub. No.: US 2018/0005598 A1
(43) Pub. Date: Jan. 4, 2018

(54) OLED-AWARE CONTENT CREATION AND CONTENT COMPOSITION

(71) Applicant: Intel Corporation, Santa Clara, CA (US)

(72) Inventors: Srikanth Kambhatla, Portland, OR (US); Zhiming J. (Jim) Zhuang, Sammamish, WA (US); Jun Jiang, Portland, OR (US); Aaron J. Steyskal, Portland, OR (US)

(21) Appl. No.: 15/196,304

(22) Filed: Jun. 29, 2016

(51) Int. Cl. G09G 5/10; G09G 3/20; G09G 3/3208

(52) U.S. Cl. CPC G09G 5/10; G09G 3/3208; G09G 3/2003; G09G 2320/0242; G09G 2320/046; G09G 2320/0233

(57) ABSTRACT

Organic Light Emitting Diode (OLED)-aware content creation and composition are disclosed. In one embodiment, the computing system comprises an Organic Light Emitting Diode (OLED) display, a memory to store history data of known pixel usage of the OLED display, and a processor coupled to the memory and the OLED display to manipulate content to be displayed on the OLED display based on the history data.

### FIELD OF THE INVENTION

Embodiments of the present invention relate to the field of computing devices; more particularly, embodiments of the present invention relate to generating content for display on organic light emitting diode (OLED) displays of computing devices based on pixel damage associated with such OLED displays.

### BACKGROUND OF THE INVENTION

Degradation in OLED displays is characterized by the loss of luminance over time. The rate of this degradation is different for each pixel since the pixels that make up an OLED display (or panel) are used unevenly based on the content that is being displayed. Also, the degradation rate is different for each of the three primary colors of a pixel. For example, a blue sub-pixel degrades faster than red and green sub-pixels. Differences in degradation rate for pixels accumulates over time to cause undesirable effects such as color shift or burn-in—and this is one of the key challenges that needs to be solved to enable wide adoption of OLED displays in personal computers (PCs).

Compensation techniques can be applied to OLED displays to prolong the useful life of an OLED panel despite the burn-in effect. These compensation techniques typically depend on knowledge of sub-pixel-level history of the content that was displayed, which is also referred to as accumulated data. Compensation techniques can visually reduce the effects of burn-in but they are compute-intensive causing an increase in power consumption. For example, current techniques to delay onset of burn-in focus on reducing the average pixel usage time by manipulating the generated/composed content with the goal of distributing the “damage” to pixels. Also once compensation kicks in, stopping it results in the visual artifacts showing up again. Therefore, it is desirable to delay the onset of burn-in in addition to any compensation techniques that are used.

Post-composition manipulation of content is replete with power, quality, and user experience issues—so this reduction in the need for such techniques is significant. Damage-avoidance techniques have targeted transparency of content that is displayed statically for long duration, auto-hiding content when it is not needed, lowering the brightness, or manipulating the content (frame buffer) that has already been generated. Transparency and auto-hiding are techniques that are applied once the content to be displayed and its position have already been determined. In that sense, they are also manipulating content that has already been generated. Brightness reduction too is not manipulating the content; rather it is manipulating the display apparatus so extent of damage is reduced.

Since the end user expects the image in a certain way, a significant amount of computation is required to maintain that illusion while distributing the damage without the user knowing. That is, manipulation of content generated needs to create the illusion that the content is not being manipulated; any noticeable difference from the intent of the content creator is a fundamental problem. Maintaining the impression that content is not being manipulated requires complex algorithms that consume significant power. This significantly increases the power consumed or forces trade-offs between power consumed and visual artifacts avoided.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a flow diagram of one embodiment of a computing system displaying content based on history data.

FIG. 2 is a sequence diagram illustrating one embodiment of an OLED-aware content generation process.

FIG. 3A illustrates an example of a non-OLED-aware application that moves a relatively bright logo along a random trace.

FIG. 3B illustrates an example of content generation by an OLED-aware application for the content of the example in FIG. 3A.

FIG. 4 illustrates another example of the use of OLED-aware applications that manipulate content based on history of pixel usage.

FIGS. 5A and 5B illustrate another example of the use of an OLED-aware composer.

FIG. 6 illustrates shows the start menu as shown by a traditional non-OLED-aware composer.

FIG. 7 illustrates a task bar that has been split into two parts by the OLED-aware composer.

FIG. 8 is a flow diagram of one embodiment of a process for displaying content on an OLED display.

FIG. 9 is flow diagram of one embodiment for a process for maintaining history data of known pixel usage for an OLED display

FIG. 10 is a more detailed flow diagram of one embodiment of a process for displaying content on a OLED display.

FIG. 11 is one embodiment of a system level diagram.

### DETAILED DESCRIPTION OF THE PRESENT INVENTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

The techniques described herein are employed by a computing system during content generation and content composition in order to delay the onset of pixel damage of an organic light emitting diode (OLED) display (panel) and/or to avoid further damaging the OLED display. The computing device may be a notebook computer system, tablet, smart phone, personal digital assistant (PDA), personal computer (PC), or other type of device having an OLED display. In one embodiment, these techniques operate without incurring significant impact to power consumption.

In one embodiment, the entities in a computing system that generate content or compose content employ the techniques described herein in order to avoid or delay pixel damage on the OLED display. In one embodiment, these entities include applications running on the computing system and/or the operating systems (OSs). Thus, the responsibility for damage avoidance is moved up stream to the applications and/or the OSs. In one embodiment, these entities generate content or compose content with history data indicative of the pixel damage and/or more frequently used pixels of an OLED display so they use the more aged pixels/areas less frequently (and use the less aged pixels more frequently), thereby delaying the onset of burn-in. When content is generated and/or composed in this history-aware manner, there is a reduced need to manipulate content after it has been generated.

In one embodiment, pre-composition damage-onset-avoidance techniques are combined with other compensation techniques that are applicable after onset of damage. In one embodiment, post-composition damage-onset-avoidance techniques are used in some scenarios.

When damage distribution is performed before content to be displayed has been finalized, most of the problems discussed above can be avoided or their impact reduced.

### History-Aware Content Generation

In one embodiment, the computing system having an OLED display executes a class of applications that are OLED-aware. In one embodiment, these applications have an inherent freedom to either add content or change color of rendered content at locations within the window (screen space) it is assigned, without impacting the end user expectation. An example of such an application is a screensaver, which can choose to create or move objects unilaterally without user input, and there is not pre-determined sense of correctness in the user's mind in this regard. An example of an application that is not able to do this is a productivity application (a word processing program (e.g., Microsoft Word), a slide program (e.g., Microsoft PowerPoint), an email program (e.g., Microsoft Outlook) since the user expects the content to be shown in a certain ordered manner.

In one embodiment, history data for content that has been displayed in the OLED display screen is tracked and maintained. The history data is stored in a memory in the computing system. In one embodiment, the history data is maintained by a graphic processing unit's (GPU's) device driver in the computing system (e.g., a notebook computer). In one embodiment, the device driver analyzes this history data periodically to generate and/or update a damage signature representative of the damage that has occurred in the screen. In another embodiment, the history data could also be tracked and analyzed within the Operating System (OS) after the composition has occurred, without the GPU driver being aware this is occurring. In yet another embodiment, this could also be implemented in a ‘filter driver’ that intercepts the frames being output by the OS to the GPU driver with the intent of maintaining the history data and performing this analysis. Such a filter driver would work in conjunction with the GPU driver or the OS to make the damage signature available for use.

In one embodiment, this damage signature is a set of priority levels assigned to regions of screen based on damage that has occurred: heavily aged pixels/regions get low priority, less used pixels/regions get high priority for future usage. In another embodiment, this damage signature includes data prioritizing specific sub-pixels to be favored (given that damage for different sub-pixels could be different).

In one embodiment, the device driver makes this damage signature available to the OS periodically. In one embodiment, the OS provides the damage signature to applications (e.g., OLED-aware applications). In an alternative embodiment, the device driver provides the damage signature to the applications directly.

When an OLED-aware application is launched, the application interacts with the OS to indicate its readiness to receive the damage signature. The OS sends the application the subset of the damage signature that overlaps with the display screen coordinates of the application's window. It is possible that the screen coordinates of the application's window includes the entire screen. Once an OLED-aware application receives this data, the application generates content to be displayed based on this (potential subset of the) damage signature.

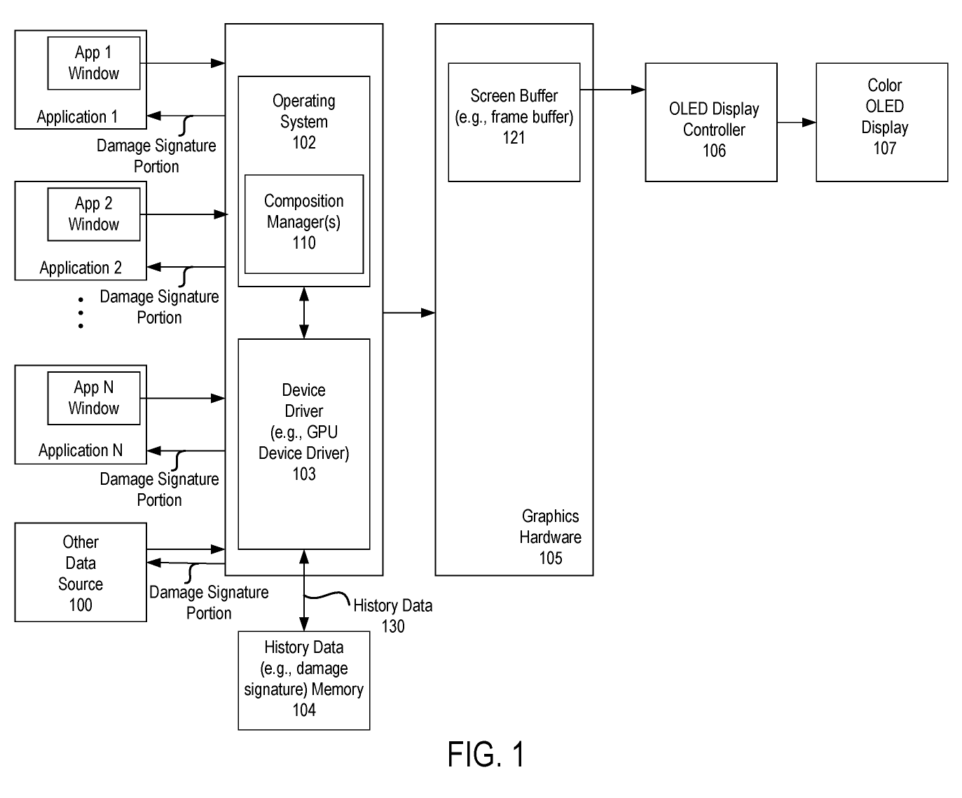

FIG. 1 is a flow diagram of one embodiment of a computing system displaying content based on history data. Referring to FIG. 1, in one embodiment, one or more of applications, such as applications 1 through N, are executing in the computing system. These may be executed by one or more cores, one or more central processing units (CPUs), one or more graphics processing units (GPUs). In one embodiment, one or more of applications 1 through N is an OLED-aware application to generate content for display on an OLED display 107 based on history data 130 indicative of damage and/or use of pixels in the OLED display. Note that there may be one or more other data sources, such as data source 100, that provide data for display on OLED display 107.

In one embodiment, the system includes at least one operating system, such as operating system 102, and one or more device drivers, such as device driver 103 (e.g., a GPU device driver, etc.). In one embodiment, device driver 103 tracks history data 130 associated with OLED display 107 and stores history data 130 in history data memory 104. In one embodiment, history data 130 comprises a damage signature as described herein. In one embodiment, device driver 103 provides history data 130 (e.g., damage signature) to each OLED-aware application, or at least the portion of history data 130 relevant to the application (e.g., the history data corresponding to the screen coordinates of a window that the application is to generate).

In response to the history data, each of the OLED-aware applications generates content for display based on the history data. In one embodiment, the content from applications 1-N and data source(s) 100, if any, are sent to graphics hardware 105 via a kernel under control of device driver 103 and OS 102. In one embodiment, the data corresponding to the content is stored in screen buffer 121 (e.g., a frame buffer). From screen buffer 121, the data corresponding to the content is displayed on color OLED display 107 under control of OLED display controller 106.

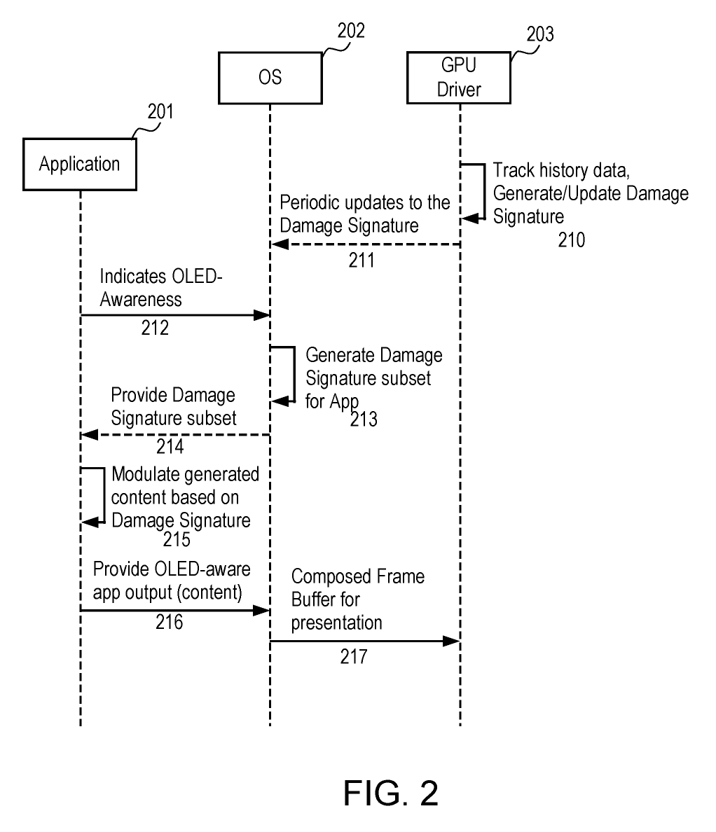

FIG. 2 is a sequence diagram illustrating one embodiment of an OLED-aware content generation process. The sequence is performed by processing logic that may comprise hardware (circuitry, dedicated logic, etc.), software (such as is run on a general purpose computer system or a dedicated machine), firmware, or a combination of the three.

Referring to FIG. 2, the sequence begins by driver 203 (e.g., GPU driver 203) tracking history data and generating and/or updating a damage signature (processing block 210). In one embodiment, each pixel on the display screen is tracked. Driver 203 sends periodic updates of the damage signature to OS 202 (processing block 211). One or more applications, such as application 201, indicates their OLED-awareness to OS 202 (processing block 212). In response thereto, OS 202 generates a damage signature subset for the application (processing block 213) and sends that damage signature subset to application 201 (processing block 214). Application 201 modulates or varies attributes (e.g., color, position, etc.) of generated content based on the damage signature (processing block 215) and provides the OLED-aware application output (e.g., content) to OS 201 (processing block 216), which provides the compressed frame buffer for presentation to driver 213 (processing block 217).

As shown in FIG. 2, the sequence is in contrast to current techniques such as dithering or screen saver etc. that randomly manipulate the pixel's location, so that using the techniques described herein over time will cause, in one embodiment, a statistically averaged effect is even usage of pixels on the whole screen or applied areas.

Thus, as set forth in FIGS. 1 and 2 above, the disclosed techniques selectively manipulate the pixel usage based on known history of pixels to adjust the pixels usage in such a way that the un-evenness usage among pixels will be re-balanced overtime.

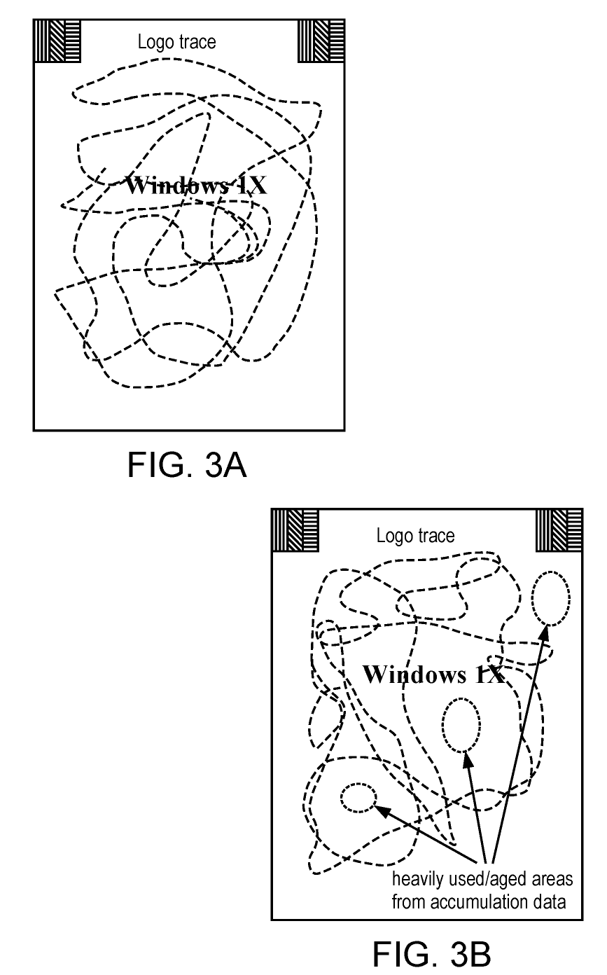

FIG. 3A illustrates an example of a non-OLED-aware application that moves a relatively bright logo along a random trace. With such a random trace, the statistically averaged effect over time is that the logo will cover the entire display areas and use all pixels evenly.

In one embodiment, if that application was OLED-aware, as shown in FIG. 3B, the application moves the logo along a trace selected based on priority information in the damage signature returned by the OS, and purposely avoids previously heavily used/aged pixels/regions. Thus, previously less used/aged pixels get more usage.

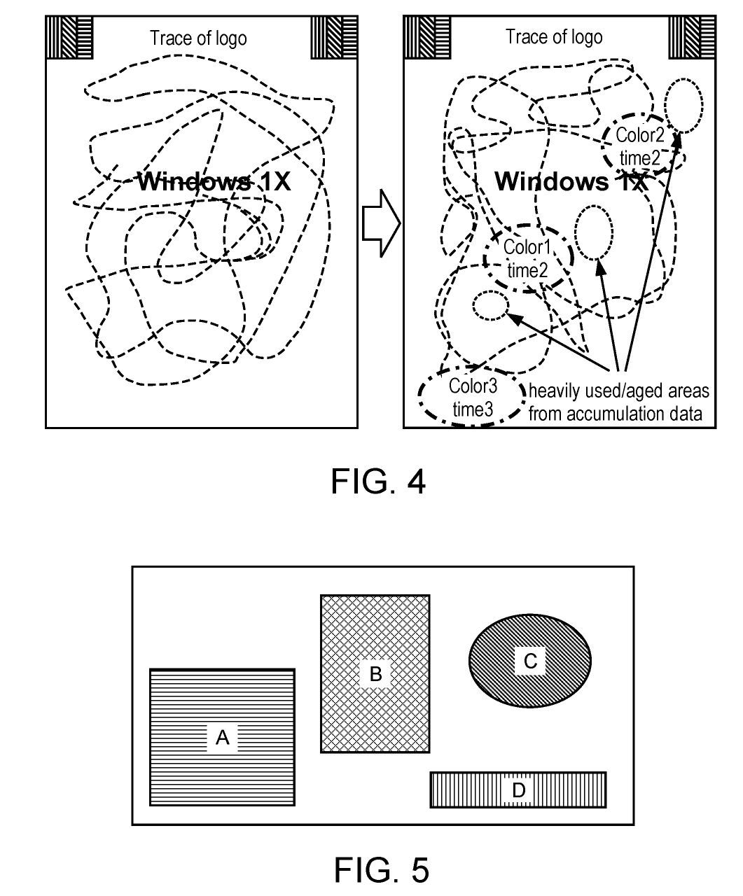

FIG. 4 illustrates another example of the use of OLED-aware applications that manipulate content based on history of pixel usage (e.g., pixel damage, a damage signature, etc.). Referring to FIG. 4, an OLED-aware application also uses R, G, B sub-pixel usage information in the damage signature to generate content. If the application determines from the damage signature that a blue sub-pixel is aged more than other sub-pixels, then the application generates content favoring red or green colors. In this case, the OLED-aware application not only moves the logo selectively, thereby ensuring less aged areas get more coverage, it also determines what color is to be used in those select regions/locations. Thus, the trace of the logo is in the color green. Also, the application avoids generating content in three areas of heavy use/aged pixel areas identified from the history data that has been accumulated.

In another embodiment, an OLED-aware application controls the frequency at which it generates content to update the OLED display screen. By controlling the frequency of the updates, the frequency by which certain pixels are used is reduced, thereby reducing the amount of damage to the pixels. Note that in one embodiment, the OS may control the updating of the OLED display screen. In such a case, the applications operate in response to control from the OS.

### History Aware Content Composition

In one embodiment, the composition of content for display is made based on history data (e.g., a damage signature). In one embodiment, this is performed using code that is responsible for composing rendered content. Examples of such code are the composition manager(s) in an OS, or the portion of an application that composes rendered output from other parts of an application to generate the final output of the application. For purposes herein, the class of composers that benefit from this technique are referred to herein as OLED-aware composers. These composers take into account the damage signature before determining where the output from applications are composed in the final frame buffer. Note that in one embodiment, the composition manager 110 of OS 102 of FIG. 1 performs the functions of an OLED-aware composer.

More specifically, in one embodiment, each application has a buffer or window to generate its content that is to appear on the OLED display screen. The OS using a list of damaged pixel locations, or an indication of the pixel usage in each such window, can control the content that placed in the frame buffer for the entire OLED display screen in order to reduce further damage or avoid damage to the OLED display. In other words, once the OS has the window data from the applications, it can compose them into the final frame buffer.

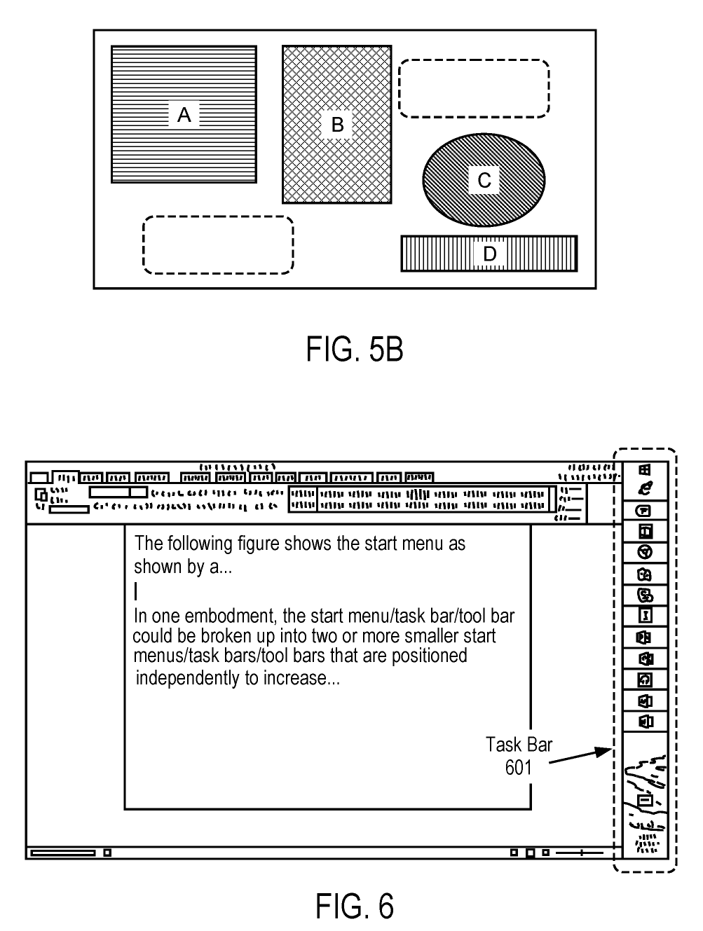

FIGS. 5A and 5B illustrate another example of the use of an OLED-aware composer. Referring to FIG. 5A, a non-OLED-aware composer blends in the output of four applications (A, B, C, and D) either based on user input or some default policy. Referring to FIG. 5B, an OLED-aware composer takes into account regions that have higher damage than others and would consciously compose an output of applications to avoid those regions. As shown in FIG. 5B, the dotted redlines indicate the regions with higher damage and thus the OLED-aware composer composes the output to avoid these regions.

Note that depending on the extent of damage and the nature of output from the applications, it may not be possible to eliminate use of regions with high damage. Still an OLED-aware composer should be able to reduce further damage by avoiding those regions to the extent possible.

In one embodiment, an OLED-aware composer (together with the “shell” layer of an OS that controls the user interface) makes use of the damage signature to alter the way commonly and constantly used OS gadgets, icons, or start menus/taskbars/toolbars are presented.

FIG. 6 illustrates shows the start menu as shown by a traditional non-OLED-aware composer. Referring to FIG. 6, a task bar 601 is display on the right side of the OLED display.

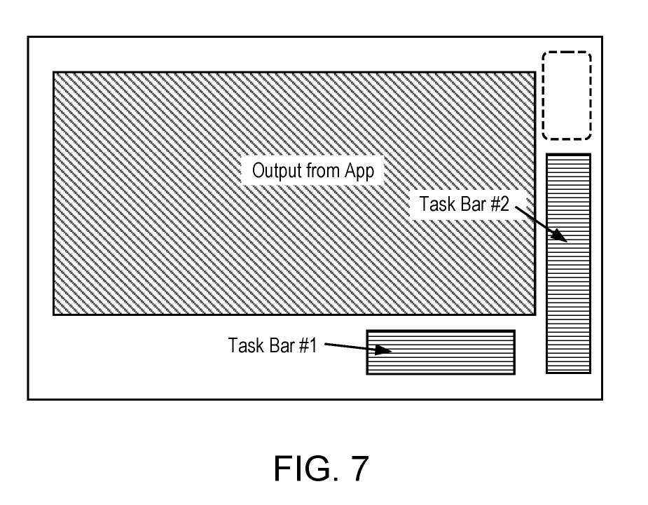

In one embodiment, the start menu/taskbar/tool bar is broken up into two or more smaller start menus/task bars/tool bars that are positioned independently to increase the chance of avoiding high damage regions. FIG. 7 illustrates a task bar that has been split into two parts, task bar #1 and task bar #2, by the OLED-aware composer. Also, the OLED-aware composer has avoided putting content, including any part of the task bar, in the high damage region indicated by the dotted lines.

In another embodiment, the start menu/task bar/tool bar may be relocated dynamically to other regions of the OLED display screen during the composition phase.

Note that if the OS relocates any start menu/task bar/tool bar or window of an application, in one embodiment, the application is notified by the OS to ensure functionality associated with the user interfacing and/or interacting with such user interface elements is sent to and/or acted on by the application.

In yet another embodiment, the color of the gadgets/tools comprising the start menu/task bar/tool bar may be changed if the damage signature shows that certain sub-pixels show more damage than others.

In one embodiment, the user has opt into a mode to enable the composition manager in an operating system to enable OLED-aware composition. In one embodiment, the mode is entered with a setting on a control panel. In another embodiment, the mode is entered by a setting in a configuration memory. Similarly, the system could enable a user to disable any such OLED-aware operation.

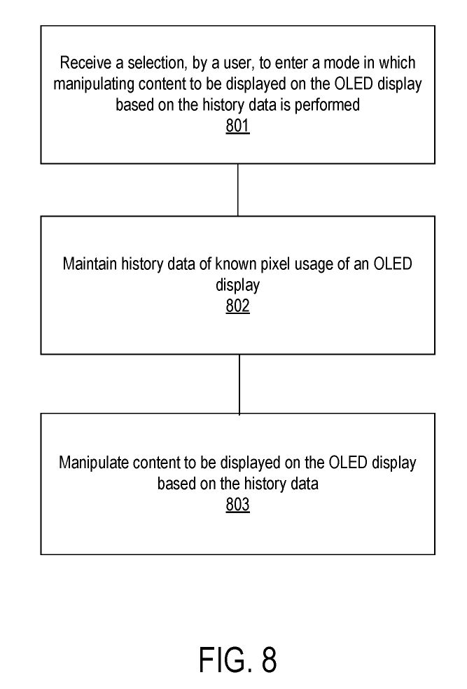

FIG. 8 is a flow diagram of one embodiment of a process for displaying content on a OLED display. The process is performed by processing logic that may comprise hardware (circuitry, dedicated logic, etc.), software (such as is run on a general purpose computer system or a dedicated machine), firmware, or a combination of the three. In one embodiment, the process is performed by the system components in FIG. 1.

Referring to FIG. 8, the process begins by receiving a selection, by a user, to enter a mode in which manipulating content to be displayed on the OLED display based on the history data is performed (processing block 801).

If such an OLED aware mode has been entered, processing logic maintains history data of known pixel usage of an OLED display (processing block 802). In one embodiment, the history data indicates regions of the OLED display having damaged pixels. In another embodiment, the history data indicates frequency of use of pixels of the OLED display. In yet another embodiment, the history data comprises data for content that has been shown on the OLED display screen. In still another embodiment, the history data comprises data indicating portions (regions) of the OLED display desirable for less frequent use for damage avoidance.

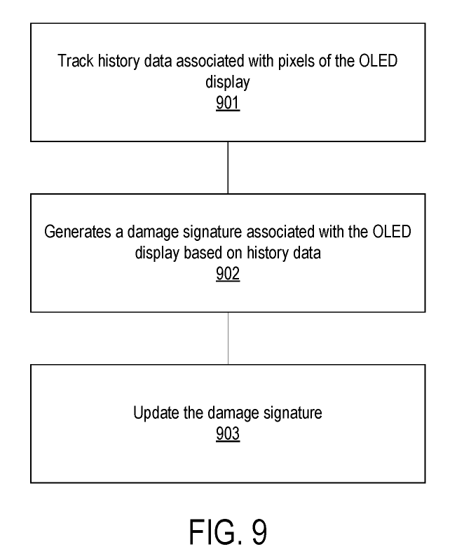

FIG. 9 is flow diagram of one embodiment for a process for maintaining history data of known pixel usage for an OLED display. The process is performed by processing logic that may comprise hardware (circuitry, dedicated logic, etc.), software (such as is run on a general purpose computer system or a dedicated machine), firmware, or a combination of the three. In one embodiment, the process is performed by the system components in FIG. 1.

Referring to FIG. 9, the process begins by tracking history data associated with pixels of the OLED display (processing block 901). Based on the history data, processing logic generates a damage signature associated with the OLED display (processing block 902). Processing logic periodically updates the damage signature (processing block 903). In one embodiment, the damage signature is updated whenever the entity generating it detects change in a threshold of damage. In one embodiment, there could be multiple levels of damage that correspond to priorities at which pixel usage needs to be avoided.

Referring back to FIG. 8, processing logic manipulating content to be displayed on the OLED display based on the history data (processing block 803). In one embodiment, manipulating content comprises using one or both of: one or more damage-onset-avoidance techniques; and one or more compensation techniques that are applicable after onset of pixel damage, to render content for display. In one embodiment, manipulating content comprises adjusting pixel usage to reduce usage of locations in the OLED display with damaged pixels or pixels used more frequently than other locations in the OLED display. In another embodiment, manipulating content is performed in such a way as to make usage of pixels of the OLED display occur more balanced over time. In yet another embodiment, manipulating content comprises performing one or more of: moving content designated for display on a first portion of the OLED display to a second portion of the OLED display; changing content; and selecting color for content. In one embodiment, selecting a color for content comprises changing color intensity of content to be displayed.

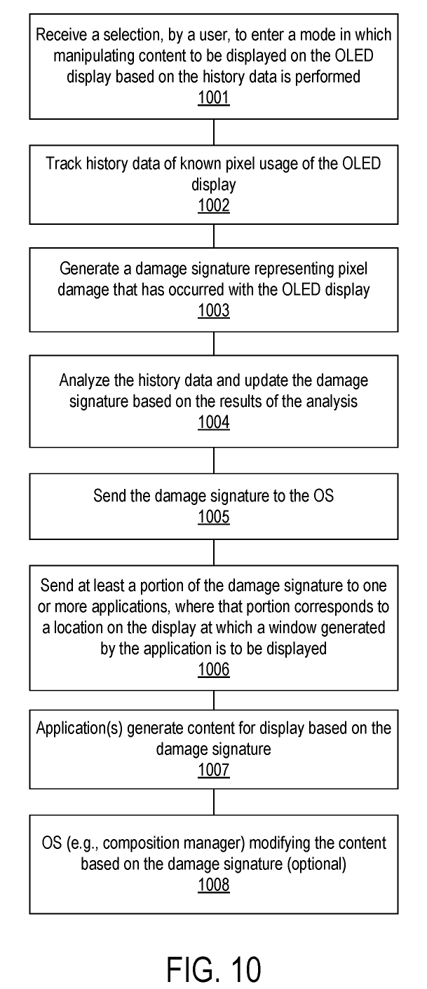

FIG. 10 is a more detailed flow diagram of one embodiment of a process for displaying content on an OLED display. The process is performed by processing logic that may comprise hardware (circuitry, dedicated logic, etc.), software (such as is run on a general purpose computer system or a dedicated machine), firmware, or a combination of the three. In one embodiment, the process is performed by the system components in FIG. 1.

Referring to FIG. 10, the process begins by receiving a selection, by a user, to enter a mode in which manipulating content to be displayed on the OLED display based on the history data is performed (processing block 1001).

If such an OLED aware mode has been entered, processing logic tracks history data of known pixel usage of the OLED display (processing block 1002). In one embodiment, history is maintained at sub-pixel level. In other embodiments, history is maintained at pixel level or at the level of several blocks of pixels. In one embodiment, the pixel usage data is data indicating more frequently used pixels. In another embodiment, the pixel usage data is data indicating less frequently used pixels. In yet another embodiment, the pixel usage data is data indicating damaged pixels (or sub-pixels).

Based on the history data, processing logic generates a damage signature representing pixel damage that has occurred with the OLED display (processing block 1003). In one embodiment, the damage signature specifies regions of pixels of the OLED display containing higher damage. In another embodiment, the damage signature contains sub-pixel level damage for pixels of the OLED display. In yet another embodiment, the damage signature indicates priority levels assigned to different regions of the screen based on damage that has occurred to influence future use of each of the different regions. In still another embodiment, the damage signature includes data specifying specific sub-pixels to be favored for future use given the damage that has occurred.

Optionally, processing logic analyzes the history data and updates the damage signature based on the results of the analysis (processing block 1004). In one embodiment, the tracking of history data, the generation of the damage signature and subsequent analysis of the history data are performed by a device driver, such as, for example, the GPU's device driver by which content for the OLED display is sent. Note that one or more of these functions could be performed by other processing logic. For example, one or more of these functions could be performed internally in the OS after the frame has been composed, or in a filter driver as mentioned above.

In one embodiment, once the damage signature has been generated or updated, processing logic sends the damage signature to the OS (processing block 1005) and processing logic of the OS sends at least a portion of the damage signature to one or more applications, where that portion corresponds to a location on the display at which a window generated by the application is to be displayed (processing block 1006).

Using the damage signature, or portion thereof, processing logic of each of the one or more application generates content for display based on the damage signature (processing block 1007). In this way, in one embodiment, these applications use the damage signature to modulate one or more of content placement and color choice.

In one embodiment, generating content using the damage signature optionally comprises the OS (e.g., composition manager) modifying the content, based on the damage signature (processing block 1008). In one embodiment, the OS modifies content based on the damage signature by determining where output from one or more applications are composed in the frame buffer based on the damage signature. In another embodiment, generating content for display based on the damage signature comprises relocating dynamically one or more parts of content to be displayed on a first region of the OLED display to second region of the OLED display during composition.

In one embodiment, generating content using the damage signature comprises one or more composition managers in the OS using the damage signature to compose output from one or more applications to avoid damaged areas of the OLED display, if possible. In one embodiment, the one or more composition managers in the OS use the damage signature to compose output from one or more applications by having the OS, based on the damage signature, divide a graphical user interface (GUI) element (e.g., task bar, menu, etc.) into multiple portions and relocate one or more the plurality of portions to a new location on the OLED display other than their originally designated locations, dynamically relocate the GUI element, or dynamically change one or more colors of a graphical representation (e.g., an icon) of a file or program.

Note that processing block 1008 may be performed even if there are no OLED-aware applications in the system or if there are other non-OLED aware applications contributing content for display on the OLED display.

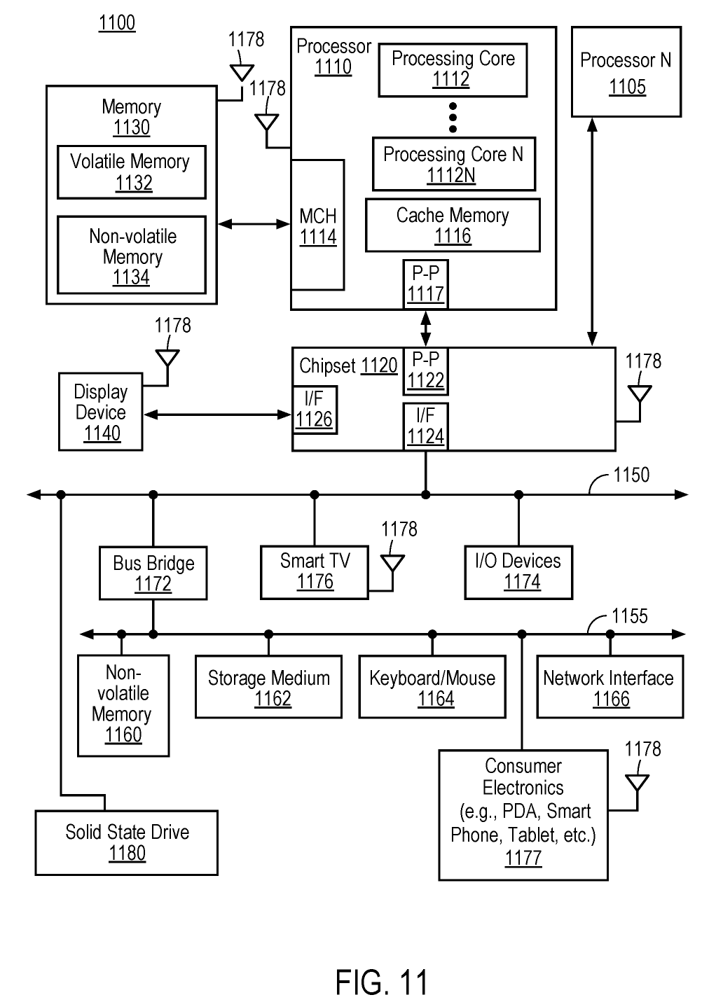

FIG. 11 is one embodiment of a system level diagram 1100 that may incorporate the techniques described above. For example, the techniques described above may be used in conjunction with a processor in system 1100 or other part of system 1100.

Referring to FIG. 11, system 1100 includes, but is not limited to, a desktop computer, a laptop computer, a netbook, a tablet, a notebook computer, a personal digital assistant (PDA), a server, a workstation, a cellular telephone, a mobile computing device, a smart phone, an Internet appliance or any other type of computing device. In another embodiment, system 1100 implements the methods disclosed herein and may be a system on a chip (SOC) system.

In one embodiment, processor 1110 has one or more processor cores 1112 to 1112N, where 1112N represents the Nth processor core inside the processor 1110 where N is a positive integer. In one embodiment, system 1100 includes multiple processors including processors 1110 and 1105, where processor 1105 has logic similar or identical to logic of processor 1110. In one embodiment, system 1100 includes multiple processors including processors 1110 and 1105 such that processor 1105 has logic that is completely independent from the logic of processor 1110. In such an embodiment, a multi-package system 1100 is a heterogeneous multi-package system because the processors 1105 and 1110 have different logic units. In one embodiment, processing core 1112 includes, but is not limited to, pre-fetch logic to fetch instructions, decode logic to decode the instructions, execution logic to execute instructions and the like. In one embodiment, processor 1110 has a cache memory 1116 to cache instructions and/or data of the system 1100. In another embodiment of the invention, cache memory 1116 includes level one, level two and level three, cache memory, or any other configuration of the cache memory within processor 1110.

In one embodiment, processor 1110 includes a memory control hub (MCH) 1114, which is operable to perform functions that enable processor 1110 to access and communicate with a memory 1130 that includes a volatile memory 1132 and/or a non-volatile memory 1134. In one embodiment, memory control hub (MCH) 1114 is positioned outside of processor 1110 as an independent integrated circuit.

In one embodiment, processor 1110 is operable to communicate with memory 1130 and a chipset 1120. In such an embodiment, SSD 1180 executes the computer-executable instructions when SSD 1180 is powered up.

In one embodiment, processor 1110 is also coupled to a wireless antenna 1178 to communicate with any device configured to transmit and/or receive wireless signals. In one embodiment, wireless antenna interface 1178 operates in accordance with, but is not limited to, the IEEE 802.11 standard and its related family, HomePlug AV (HPAV), Ultra Wide Band (UWB), Bluetooth, WiMAX, or any form of wireless communication protocol.

In one embodiment, the volatile memory 1132 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. Non-volatile memory 1134 includes, but is not limited to, flash memory (e.g., NAND, NOR), phase change memory (PCM), read-only memory (ROM), electrically erasable programmable read-only memory (EEPROM), or any other type of non-volatile memory device.

Memory 1130 stores information and instructions to be executed by processor 1110. This may include applications, operating systems, and device drivers. In one embodiment, chipset 1120 connects with processor 1110 via Point-to-Point (PtP or P-P) interfaces 1117 and 1122. In one embodiment, chipset 1120 enables processor 1110 to connect to other modules in the system 1100. In one embodiment, interfaces 1117 and 1122 operate in accordance with a PtP communication protocol such as the Intel QuickPath Interconnect (QPI) or the like.

In one embodiment, chip set 1120 is operable to communicate with processor 1110, 1105, display device 1140 (e.g., an OLED display), and other devices 1172, 1176, 1174, 1160, 1162, 1164, 1166, 1177, etc. In one embodiment, chipset 1120 is also coupled to a wireless antenna 1178 to communicate with any device configured to transmit and/or receive wireless signals.

In one embodiment, chip set 1120 connects to a display device 1140 via an interface 1126. In one embodiment, display device 1140 includes, but is not limited to, liquid crystal display (LCD), plasma, cathode ray tube (CRT) display, or any other form of visual display device. In addition, chipset 1120 connects to one or more buses 1150 and 1155 that interconnect various modules 1174, 1160, 1162, 1164, and 1166. In one embodiment, buses 1150 and 1155 may be interconnected together via a bus bridge 1172 if there is a mismatch in bus speed or communication protocol. In one embodiment, chipset 1120 couples with, but is not limited to, a non-volatile memory 1160, a mass storage device(s) 1162, a keyboard/mouse 1164, and a network interface 1166 via interface 1124, smart TV 1176, consumer electronics 1177, etc.

In one embodiment, mass storage device 1162 includes, but is not limited to, a solid state drive, a hard disk drive, a universal serial bus flash memory drive, or any other form of computer data storage medium. In one embodiment, network interface 1166 is implemented by any type of well-known network interface standard including, but not limited to, an Ethernet interface, a universal serial bus (USB) interface, a Peripheral Component Interconnect (PCI) Express interface, a wireless interface and/or any other suitable type of interface.

While the modules shown in FIG. 11 are depicted as separate blocks within the system 1100, the functions performed by some of these blocks may be integrated within a single semiconductor circuit or may be implemented using two or more separate integrated circuits.

In a first example embodiment, a computing system comprises an Organic Light Emitting Diode (OLED) display, a memory to store history data of known pixel usage of the OLED display, and a processor coupled to the memory and the OLED display to manipulate content to be displayed on the OLED display based on the history data.

In another example embodiment, the subject matter of the first example embodiment can optionally include that the history data indicates frequency of use of sub-pixels of the OLED display.

In another example embodiment, the subject matter of the first example embodiment can optionally include that the history data indicates regions of the OLED display having damaged pixels.

In another example embodiment, the subject matter of the first example embodiment can optionally include that the history data indicates priority at which further usage of identified pixels should be avoided due to usage across pre-identified threshold levels.

In another example embodiment, the subject matter of the first example embodiment can optionally include that the processor is operable to manipulate the content by using one or both of: one or more damage-onset-avoidance techniques; and one or more compensation techniques that are applicable after onset of pixel damage, to render content for display.

In another example embodiment, the subject matter of the first example embodiment can optionally include that the processor is operable to manipulate the content by adjusting pixel usage to reduce usage of locations in the OLED display with damaged pixels or pixels used more frequently than other locations in the OLED display.

In another example embodiment, the subject matter of the first example embodiment can optionally include that the processor is operable to manipulate the content in such a way as to make usage of pixels of the OLED display occur more balanced over time.

In another example embodiment, the subject matter of the first example embodiment can optionally include that the processor is operable to manipulate the content by one or more of a group consisting of: moving content designated for display on a first portion of the OLED display to a second portion of the OLED display; changing content; and selecting color for content. In another example embodiment, the subject matter of this example embodiment can optionally include that selecting a color for content comprises changing color intensity of content to be displayed.

In another example embodiment, the subject matter of the first example embodiment can optionally include that the one or more processors are operable to execute one or more applications, which when executed by the one or more processors, are operable to generate content for display based on at least a portion of a damage signature representing pixel damage that has occurred with the OLED display, the at least a portion corresponding to a location on the display at which a window generated by the application is to be displayed. In another example embodiment, the subject matter of this example embodiment can optionally include that the one or more processors are operable to: analyze history data of pixels of the OLED display periodically to update the damage signature; and provide the damage signature to an operating system (OS). In another example embodiment, the subject matter of this example embodiment can optionally include that the processor is operable to execute an OS, which provides the damage signature to the one or more applications, which use the damage signature to modify one or more of content placement and color choice. In another example embodiment, the subject matter of this example embodiment can optionally include that the processors is operable to execute a device driver that analyzes the history data and provides the damage signature to the OS.

In another example embodiment, the subject matter of the first example embodiment can optionally include that the processor is operable to execute one or more applications, which when executed by the processor, are operable to generate content and execute one or more composition managers in the operating system to compose an output for the OLED display using content from the one or more applications based on at least a portion of a damage signature representing pixel damage that has occurred with the OLED display. In another example embodiment, the subject matter of this example embodiment can optionally include that the one or more composition managers in the OS using the damage signature are operable to divide a graphical user interface (GUI) element into multiple portions and relocate one or more the plurality of portions to a new location on the OLED display other than their originally designated location, dynamically relocate the GUI element, or dynamically change one or more colors of a graphical representation of a file or program.

In another example embodiment, the subject matter of the first example embodiment can optionally include that the damage signature indicates priority levels assigned to different regions of the screen based on damage that has occurred to influence future use of each of the different regions.

In another example embodiment, the subject matter of the first example embodiment can optionally include that the damage signature includes data specifying specific sub-pixels to be favored for future use given the damage that has occurred.

In another example embodiment, the subject matter of the first example embodiment can optionally include that the processor is operable to execute an operating system that modifies the content based on the damage signature. In another example embodiment, the subject matter of this example embodiment can optionally include that the OS modifies the content based on the damage signature by determining where by composing an output from the one or more applications in a frame buffer based on the damage signature.

In another example embodiment, the subject matter of the first example embodiment can optionally include that the processor is operable to generate content for display based on the damage signature comprises relocating dynamically one or more parts of content to be displayed on a first region of the OLED display to second region of the OLED display during composition.

In another example embodiment, the subject matter of the first example embodiment can optionally include that the processor is responsive to a user selecting entry into a mode in which manipulating content to be displayed on the OLED display based on the history data is performed.

In a second example embodiment, a method comprises maintaining history data of known pixel usage of an Organic Light Emitting Diode (OLED) display, and modulating content to be displayed on the OLED display based on the history data.

In another example embodiment, the subject matter of the second example embodiment can optionally include that the history data indicates frequency of use of pixels of the OLED display.

In another example embodiment, the subject matter of the second example embodiment can optionally include that the history data indicates regions of the OLED display having damaged pixels.

In another example embodiment, the subject matter of the second example embodiment can optionally include that modulating content comprises using one or both of: one or more damage-onset-avoidance techniques; and one or more compensation techniques that are applicable after onset of pixel damage, to render content for display.

In another example embodiment, the subject matter of the second example embodiment can optionally include that modulating content includes adjusting pixel usage to reduce usage of locations in the OLED display with damaged pixels or pixels used more frequently than other locations in the OLED display.

In another example embodiment, the subject matter of the second example embodiment can optionally include that modulating content is performed in such a way as to make usage of pixels of the OLED display occur more balanced over time.

In another example embodiment, the subject matter of the second example embodiment can optionally include that modulating content comprises one or more of a group consisting of: moving content designated for display on a first portion of the OLED display to a second portion of the OLED display; changing content; and selecting color for content.

In another example embodiment, the subject matter of the second example embodiment can optionally include: generating a damage signature representing pixel damage that has occurred with the OLED display; providing at least a portion of the damage signature to an application, the at least a portion corresponding to a location on the display at which a window generated by the application is to be displayed; and generating content for display based on the damage signature.

In a third example embodiment, an article of manufacture has one or more non-transitory computer readable storage media storing instructions which when executed by a system to perform a method comprising: maintaining history data of known pixel usage of an Organic Light Emitting Diode (OLED) display; and modulating content to be displayed on the OLED display based on the history data.

In another example embodiment, the subject matter of the third example embodiment can optionally include that the history data indicates frequency of use of pixels of the OLED display.

In another example embodiment, the subject matter of the third example embodiment can optionally include that the history data indicates regions of the OLED display having damaged pixels.

In another example embodiment, the subject matter of the second example embodiment can optionally include that modulating content comprises using one or both of: one or more damage-onset-avoidance techniques; and one or more compensation techniques that are applicable after onset of pixel damage, to render content for display.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A computing system comprising:
an Organic Light Emitting Diode (OLED) display;
a memory to store history data of known pixel usage of the OLED display; and
a processor coupled to the memory and the OLED display to manipulate content to be displayed on the OLED display based on the history data.

2. The computing system defined in claim 1 wherein the history data indicates frequency of use of sub-pixels of the OLED display.

3. The computing system defined in claim 1 wherein the history data indicates regions of the OLED display having damaged pixels.

4. The computing system defined in claim 1 wherein the history data indicates priority at which further usage of identified pixels should be avoided due to usage across pre-identified threshold levels.

5. The computing system defined in claim 1 wherein the processor is operable to manipulate the content by using one or both of:
one or more damage-onset-avoidance techniques; and
one or more compensation techniques that are applicable after onset of pixel damage, to render content for display.

6. The computing system defined in claim 1 wherein the processor is operable to manipulate the content by adjusting pixel usage to reduce usage of locations in the OLED display with damaged pixels or pixels used more frequently than other locations in the OLED display.

7. The computing system defined in claim 1 wherein the processor is operable to manipulate the content in such a way as to make usage of pixels of the OLED display occur more balanced over time.

8. The computing system defined in claim 1 wherein the processor is operable to manipulate the content by one or more of a group consisting of: moving content designated for display on a first portion of the OLED display to a second portion of the OLED display; changing content; and selecting color for content.

9. The computing system defined in claim 8 wherein selecting a color for content comprises changing color intensity of content to be displayed.

10. The computing system defined in claim 1 wherein the one or more processors are operable to execute one or more applications, which when executed by the one or more processors, are operable to generate content for display based on at least a portion of a damage signature representing pixel damage that has occurred with the OLED display, the at least a portion corresponding to a location on the display at which a window generated by the application is to be displayed.

11. The computing system defined in claim 10 wherein the one or more processors are operable to:
analyze history data of pixels of the OLED display periodically to update the damage signature; and
provide the damage signature to an operating system (OS).

12. The computing system defined in claim 11 wherein the processor is operable to execute an OS, which provides the damage signature to the one or more applications, which use the damage signature to modify one or more of content placement and color choice.

13. The computing system defined in claim 11 wherein the processors is operable to execute a device driver that analyzes the history data and provides the damage signature to the OS.

14. The computing system defined in claim 1 wherein the processor is operable to execute one or more applications, which when executed by the processor, are operable to generate content and execute one or more composition managers in the operating system to compose an output for the OLED display using content from the one or more applications based on at least a portion of a damage signature representing pixel damage that has occurred with the OLED display.

15. The computing system defined in claim 14 wherein the one or more composition managers in the OS using the damage signature are operable to divide a graphical user interface (GUI) element into multiple portions and relocate one or more the plurality of portions to a new location on the OLED display other than their originally designated location, dynamically relocate the GUI element, or dynamically change one or more colors of a graphical representation of a file or program.

16. The computing system defined in claim 10 wherein the damage signature indicates priority levels assigned to different regions of the screen based on damage that has occurred to influence future use of each of the different regions.

17. The computing system defined in claim 10 wherein the damage signature includes data specifying specific sub-pixels to be favored for future use given the damage that has occurred.

18. The computing system defined in claim 10 wherein the processor is operable to execute an operating system that modifies the content based on the damage signature.

19. The computing system defined in claim 18 wherein the OS modifies the content based on the damage signature by determining where by composing an output from the one or more applications in a frame buffer based on the damage signature.

20. The computing system defined in claim 1 wherein the processor is operable to generate content for display based on the damage signature comprises relocating dynamically one or more parts of content to be displayed on a first region of the OLED display to second region of the OLED display during composition.

21. The computing system defined in claim 1 wherein the processor is responsive to a user selecting entry into a mode in which manipulating content to be displayed on the OLED display based on the history data is performed.

22. A method comprising:
maintaining history data of known pixel usage of an Organic Light Emitting Diode (OLED) display; and
modulating content to be displayed on the OLED display based on the history data.

23. The method defined in claim 22 wherein the history data indicates frequency of use of pixels of the OLED display.

24. The method defined in claim 22 wherein the history data indicates regions of the OLED display having damaged pixels.

25. The method defined in claim 22 wherein modulating content comprises using one or both of:
one or more damage-onset-avoidance techniques; and
one or more compensation techniques that are applicable after onset of pixel damage, to render content for display.

26. The method defined in claim 22 wherein modulating content includes adjusting pixel usage to reduce usage of locations in the OLED display with damaged pixels or pixels used more frequently than other locations in the OLED display.

27. The method defined in claim 22 wherein modulating content is performed in such a way as to make usage of pixels of the OLED display occur more balanced over time.

28. The method defined in claim 22 wherein modulating content comprises one or more of a group consisting of: moving content designated for display on a first portion of the OLED display to a second portion of the OLED display; changing content; and selecting color for content.

29. The method defined in claim 21 further comprising:
generating a damage signature representing pixel damage that has occurred with the OLED display;
providing at least a portion of the damage signature to an application, the at least a portion corresponding to a location on the display at which a window generated by the application is to be displayed; and
generating content for display based on the damage signature.

30. An article of manufacture having one or more non-transitory computer readable storage media storing instructions which when executed by a system to perform a method comprising:
maintaining history data of known pixel usage of an Organic Light Emitting Diode (OLED) display; and
modulating content to be displayed on the OLED display based on the history data.

31. The article of manufacture defined in claim 30 wherein the history data indicates frequency of use of pixels of the OLED display.

32. The article of manufacture defined in claim 30 wherein the history data indicates regions of the OLED display having damaged pixels.

33. The article of manufacture defined in claim 30 wherein modulating content comprises using one or both of:
one or more damage-onset-avoidance techniques; and
one or more compensation techniques that are applicable after onset of pixel damage, to render content for display.
